(19) United States
(12) Patent Application Publication
(10) Pub. No.: US 2020/0284643 A1
(43) Pub. Date: Sep. 10, 2020

(54) AIRCRAFT LANDING WEIGHT DETERMINATION SYSTEMS AND METHODS

(71) Applicant: THE BOEING COMPANY, CHICAGO, IL (US)

(72) Inventors: Omid B. Nakhjavani, Kirkland, WA (US); Andrew J. Parker, Seattle, WA (US); James Schimert, Seabeck, WA (US); Jun Yuan, Sammamish, WA (US)

(73) Assignee: THE BOEING COMPANY, CHICAGO, IL (US)

(21) Appl. No.: 16/291,041

(22) Filed: Mar. 4, 2019

(51) Int. Cl. G01G 19/07; G01G 19/414

(52) U.S. Cl. CPC G01G 19/07; G01G 19/414

(57) ABSTRACT

An aircraft landing weight determination system and method are configured to determine an accurate gross weight of an aircraft. The aircraft landing weight determination system and method include a gross weight determination control unit that is configured to determine an accurate gross weight of an aircraft based on a first source of gross weight data of the aircraft and a second source of gross weight data of the aircraft.

### FIELD OF THE DISCLOSURE

Embodiments of the present disclosure generally relate to aircraft landing weight determination systems and methods.

### BACKGROUND OF THE DISCLOSURE

Various types of aircraft are used to transport passengers and cargo between various locations. Each aircraft typically flies between different locations according to a defined flight plan or path. For example, an aircraft departs from a departure location and flies to an arrival location.

Certain governmental regulations and airport restrictions define a maximum gross weight for a particular aircraft upon landing at an airport. That is, if the gross weight of the aircraft of the aircraft upon landing at the airport exceeds a predefined maximum weight threshold, the operating airline may be assessed a fine, for example.

The gross weight of the aircraft is the total weight of the aircraft including freight, fuel, passengers, and the like. As can be appreciated, the amount of fuel aboard an aircraft prior to take off is substantially more than the amount of fuel aboard the aircraft after the aircraft has landed at an arrival airport. That is, as fuel is burned, there is less fuel onboard the aircraft, and therefore the weight of the aircraft decreases.

However, known methods of estimating gross weight of an aircraft may not be accurate in relation to fuel quantity. Such methods may lead to overweight conditions at an arrival airport.

### SUMMARY OF THE DISCLOSURE

A need exists for a system and method for accurately estimating and determining a gross weight of an aircraft. Further, a need exists for a system and method that allow an aircraft operator to confidently predict a gross weight of an aircraft at an arrival location. Moreover, a need exists for a system and method for accurately determining a gross weight of an aircraft during a flight and predict the gross weight upon landing.

With those needs in mind, certain embodiments of the present disclosure provide an aircraft landing weight determination system that is configured to determine an accurate gross weight of an aircraft. The aircraft landing weight determination system includes a gross weight determination control unit that is configured to determine an accurate gross weight of an aircraft based on a first source of gross weight data of the aircraft and a second source of gross weight data of the aircraft. In at least one embodiment, the first source of gross weight data is gross weight 1, in which the gross weight 1 is initially determined when the aircraft is at a departure gate at a departure location. The gross weight 1 is an initial gross weight at the departure gate minus fuel burn between the departure gate and an arrival gate at an arrival location.

In at least one embodiment, the gross weight determination control unit compares the gross weight 1 to a maximum weight threshold in response to determining that the gross weight 1 is not constant during at least a portion of a flight to determine if the aircraft is in an overweight condition.

In at least one embodiment, the second source of gross weight data is gross weight 2, in which the gross weight 2 is determined when the aircraft is airborne (that is, off the ground and in the air). The gross weight 2 is determined from actual flight data when the aircraft is off the ground.

In at least one embodiment, the gross weight determination control unit compares the gross weight 2 to a maximum weight threshold in response to determining that the gross weight 1 is constant and the gross weight 2 is not constant during at least a portion of a flight to determine if the aircraft is in an overweight condition.

The gross weight determination control unit may determine the accurate gross weight of the aircraft at any point during a flight of the aircraft between a departure gate at a departure location and an arrival gate at an arrival location.

In at least one embodiment, the gross weight determination control unit predicts a gross weight of the aircraft at an arrival location before landing based on the accurate gross weight of the aircraft.

The aircraft landing weight determination system may also include a flight computer in communication with the gross weight determination control unit. The flight computer stores flight data for the aircraft.

The aircraft landing weight determination system may also include one or more fuel sensors in communication with the gross weight determination control unit. The fuel sensor(s) are configured to determine an amount of fuel onboard the aircraft.

The aircraft landing weight determination system may also include one or more weight sensors in communication with the gross weight determination control unit. The weight sensor(s) are configured to detect a gross weight of the aircraft.

The aircraft landing weight determination system may also include a weight threshold database in communication with the gross weight determination control unit. The weight threshold database stores a maximum weight threshold for the aircraft at an arrival location. The gross weight determination control unit is configured to compare the accurate gross weight of the aircraft with the maximum weight threshold to determine if the aircraft is in an overweight condition.

In at least one embodiment, the gross weight determination control unit ignores first data gaps in the first source, and ignores second data gaps in the second source. The gross weight determination control unit combines accurate gross weight data from the first source and the second source to determine the accurate gross weight of the aircraft.

Certain embodiments of the present disclosure provide an aircraft landing weight determination method that is configured to determine an accurate gross weight of an aircraft. The aircraft landing weight determination method includes determining, by a gross weight determination control unit, an accurate gross weight of an aircraft based on a first source of gross weight data of the aircraft and a second source of gross weight data of the aircraft.

In at least one embodiment, the determining includes comparing a gross weight 1 to a maximum weight threshold in response to determining that the gross weight 1 is not constant during at least a portion of a flight, comparing a gross weight 2 to the maximum weight threshold in response to determining that the gross weight 1 is constant and the gross weight 2 is not constant during at least a portion of a flight, and determining that the aircraft is in an overweight condition when the gross weight 1 or the gross weight 2 exceeds the maximum weight threshold.

The determining may include determining the accurate gross weight of the aircraft at any point during a flight of the aircraft between a departure gate at a departure location and an arrival gate at an arrival location.

The aircraft landing weight determination method may also include predicting, by the gross weight determination control unit, a gross weight of the aircraft at an arrival location before landing based on the accurate gross weight of the aircraft.

In at least one embodiment, the determining includes ignoring first data gaps in the first source, ignoring second data gaps in the second source, combining accurate gross weight data from the first source and the second source, and determining the accurate gross weight of the aircraft based on the combining.

### BRIEF DESCRIPTION OF THE DRAWINGS

FIG. 1 illustrates a simplified representation of an aircraft traveling from a departure gate to an arrival gate.

FIG. 2 illustrates a schematic box diagram of an aircraft landing weight determination system, according to an embodiment of the present disclosure.

FIG. 3 illustrates graphs of altitude, phase, gross weight 1, and gross weight 2 of the aircraft over time.

FIG. 4 illustrates graphs of gross weight 1 and gross weight 2 of the aircraft over time.

FIG. 5 illustrates a flow chart of an aircraft landing weight determination method, according to an embodiment of the present disclosure.

FIG. 6 is a diagrammatic representation of a front perspective view of an aircraft, according to an exemplary embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition may include additional elements not having that condition.

Certain embodiments of the present disclosure provide an aircraft landing weight determination system that is configured to obtain real time aircraft weight inputs including gross weight 1 (initially determined or otherwise initially established when the aircraft is on the ground) and gross weight 2 (determined when the aircraft is in the air with no weight on wheels). The two aircraft weight inputs, namely gross weight 1 and gross weight 2, are combined to derive an accurate estimate of aircraft weight, and/or an accurate fuel quantity measurement. In at least one embodiment, a pilot may take remedial action (such as flying via a different flight path to the arrival location) to ensure that the aircraft complies with governmental and airport regulations and restrictions upon landing.

Certain embodiments of the present disclosure provide systems and methods for monitoring and evaluating aircraft weight. In at least one embodiment, the systems and methods include receiving two sources of aircraft weight data. A first source is gross weight 1, which includes pre-flight and taxi data. A second source is gross weight 2, which includes in-flight data. The first source and the second source are both analyzed to determine an accurate gross weight of the aircraft, whether in flight or on the ground.

As described herein, certain embodiments of the present disclosure provide an aircraft landing weight determination system that includes a gross weight determination control unit that is configured to determine an accurate gross weight of an aircraft based on a first source of gross weight data of the aircraft and a second source of gross weight data of the aircraft. The first source of gross weight data may be gross weight 1, and the second source of gross weight data may be gross weight 2. In at least one embodiment, the gross weight determination control unit is configured to analyze the gross weight 1 and the gross weight 2 for the aircraft, such as at any point during a flight. The gross weight determination control unit is configured to determine an accurate gross weight of the aircraft based on one or both of the gross weight 1 and the gross weight 2. In at least one embodiment, the gross weight determination control unit predicts a gross weight of the aircraft at an arrival location before landing based on the accurate gross weight of the aircraft. That is, the gross weight determination control unit may determine the accurate gross weight of the aircraft at any point during a flight before landing at the arrival location, and use the accurate gross weight to predict the gross weight of the aircraft upon landing.

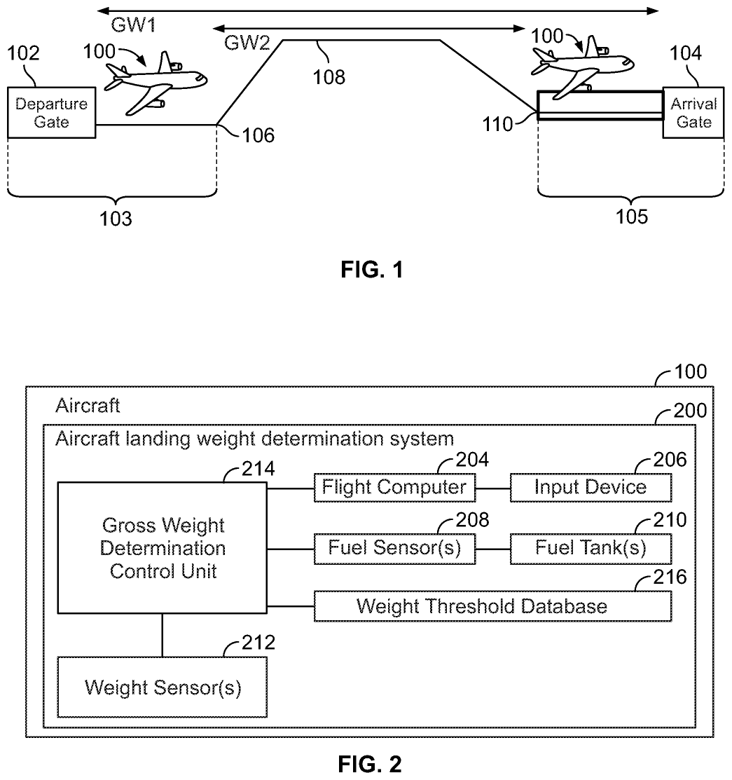

FIG. 1 illustrates a simplified representation of an aircraft 100 traveling from a departure gate 102 to an arrival gate 104. The departure gate 102 is at a departure location 103 (such as a first airport) that includes taxiway(s), runway(s), and the like. The arrival gate 104 is at an arrival location 105 (such as a second airport) that includes taxiway(s), runway(s), and the like. At the departure gate 102, crew, passengers, cargo, freight, and/or the like are boarded onto the aircraft 100. At a scheduled time, the aircraft 100 pushes back from the departure gate 102 and taxis on the ground to a runway, at which point the aircraft 100 takes off at point 106, at which the wheels of the aircraft are no longer on the ground. The aircraft 100 ascends to a cruising altitude 108 and descends towards the arrival location 105, at which point the aircraft touches down at point 110, at which the wheels of the aircraft 100 are on the ground. The aircraft 100 then taxis to the arrival gate 104, where the passengers, and crew may depart the aircraft 100.

A first source of aircraft weight is gross weight 1 (GW1). Gross weight 1 for the aircraft is determined from the departure gate 102 before the aircraft pushes back from the departure gate 102 to the arrival gate 104, and includes the time that the aircraft 100 is airborne, that is, in the air (off the ground), between points 106 and 110. In at least one embodiment, the pilot inputs the gross weight 1 of the aircraft 100 before pushing back from the departure gate 102. Gross weight 1 is calculated as an initial gross weight at the departure gate 102 minus fuel burn during the flight.

As noted, the pilot inputs the gross weight 1 at the beginning of the flight (such as at the departure gate 102, before pushback therefrom), and is then assumed constant during the entirety of the flight. For example, based on the flight path and time of flight between points 106 and 110, a fuel burn is determined. Based on the determined fuel burn, the fuel weight between the points 106 and 110 is determined. As such, gross weight 1 is based on input from the pilot, and assumes a constant decrease in weight during the in-air phases of the flight.

A second source of aircraft weight is gross weight 2 (GW2). Unlike gross weight 1, gross weight 2 is not dependent upon pilot input. Gross weight 2 is determined from actual flight data between the points 106 and 110 (when the aircraft 100 is off the ground). In at least one embodiment, gross weight 2 is determined when there is no weight on wheels of the aircraft 100 (that is, when the aircraft 100 is off the ground and in the air). Gross weight 2 is a complex calculation with different tables. Gross weight 2 is an accurate measure of gross weight of the aircraft 100 while in the air. In at least one embodiment, gross weight 2 is determined from fuel sensors on board the plane, weight sensors, engine operation and output, and/or the like. Unlike gross weight 1, gross weight 2 does not assume a constant fuel burn during the flight.

FIG. 2 illustrates a schematic box diagram of an aircraft landing weight determination system 200, according to an embodiment of the present disclosure. The aircraft 100 includes a flight computer 204 in communication with an input device 206, such as through one or more wired or wireless connections. The input device 206 may be or include a keyboard, mouse, touchscreen interface, and/or the like. The flight computer 204 stores flight data between the departure gate 102 and the arrival gate 104 (shown in FIG. 1). The flight data includes the flight path between the points 106 and 110 (shown in FIG. 1), as well as altitudes, airspeeds, and the like for the aircraft 100 during the flight.

The aircraft 100 also includes one or more fuel sensors 208 in communication with one or more fuel tanks 210. The fuel sensor(s) 208 may be on or within the fuel tank(s) 210 and are configured to determine an amount of fuel within the fuel tank(s) 210.

In at least one embodiment, the aircraft 100 also includes one or more weight sensor(s) 212. The weight sensor(s) 212 are configured to detect a gross weight of the aircraft 100.

The aircraft landing weight determination system 200 may be onboard the aircraft 100 or may be remotely located from the aircraft 100. In at least one embodiment, the aircraft landing weight determination system 200 is onboard the aircraft 100.

The aircraft landing weight determination system 200 includes a gross weight determination control unit 214 that is in communication with the flight computer 204, the fuel sensor(s) 208, the weight sensor(s) 212, and a weight threshold database 216, such as through one or more wired or wireless connections. As shown, the gross weight determination control unit 214 is onboard the aircraft 100. In at least one embodiment, the gross weight determination control unit 214 is separate and distinct from the flight computer 204. In at least one other embodiment, the gross weight determination control unit 214 is part of the flight computer 204. For example, the flight computer 204 may include the gross weight determination control unit 214.

The weight threshold database 216 stores landing weight thresholds (for example, a maximum weight threshold) for the aircraft 100 (and optionally for various other aircraft) at the arrival location 105 (shown in FIG. 1). A landing weight threshold is a gross weight magnitude at or above which the aircraft 100 is determined to be in an overweight condition at the arrival location 105.

As shown, the gross weight determination control unit 214 and the weight threshold database 216 may both be onboard the aircraft 100. In at least one other embodiment, one or both of the gross weight determination control unit 214 and the weight threshold database 216 may be remotely located from the aircraft 100. For example, the gross weight determination control unit 214 and/or the weight threshold database 216 may be at a central monitoring location (such as at an airport) and in communication with the aircraft 100.

Referring to FIGS. 1 and 2, in operation, a pilot of the aircraft 100 inputs an initial gross weight of the aircraft 100 into the flight computer 204 via the input device 206. The initial gross weight is determined through the weight sensor(s) 212, the fuel sensor(s) 208, and/or the like. For example, the initial gross weight is the gross weight of the aircraft 100 at the departure gate 102 including the weight of the aircraft 100 itself, plus the weight of the fuel within the fuel tanks(s) 210, passengers, freight, and the like. In at least one embodiment, the initial gross weight is automatically determined and input into the flight computer 204 via the weight sensor(s) 212 and the fuel sensor(s) 208 without manual input.

The gross weight determination control unit 214 receives gross weight 1 data to determine the gross weight 1 of the aircraft 100, such as at any point during the flight of the aircraft 100. For example, the gross weight determination control unit 214 receives the initial gross weight of the aircraft 100 (whether input by a pilot or automatically determined via the weight sensor(s) 212 and the fuel sensor(s) 208) and analyzes the flight plan for the aircraft 100 between the departure gate 102 and the arrival gate 104. The gross weight determination control unit 214 determines the fuel burn of the aircraft 100 based on the flight plan. The gross weight determination control unit 214 then determines gross weight 1 based on the initial gross weight of the aircraft 100 and the fuel burn. The gross weight determination control unit 214 is configured to determine the gross weight 1 of the aircraft 100 at any point between the departure gate 102 and the arrival gate 104 based on subtracting the fuel burn from the initial gross weight.

The gross weight determination control unit 214 also receives gross weight 2 data to determine the gross weight 2 of the aircraft 100, such as at any point during the flight of the aircraft 100. For example, the gross weight determination control unit 214 receives weight data from the weight sensor(s) 212, fuel data from the fuel sensor(s) 208, and/or the like during the in-air phases of the flight of the aircraft 100 between points 106 and 110. As such, the gross weight determination control unit 214 determines actual fuel burn and weight of the aircraft 100, instead of assuming a constant fuel burn based on the flight data stored in the flight computer 204. In this manner, the gross weight determination control unit 214 also determines gross weight 2.

The gross weight determination control unit 214 analyzes both gross weight 1 and gross weight 2 at any point during the flight between the departure gate 102 and the arrival gate 104 to determine an accurate gross weight of the aircraft 100 at such point in the flight, as well as make an accurate prediction of the gross weight of the aircraft 100 when the aircraft 100 lands at point 110 at the arrival location 105. In this manner, the gross weight determination control unit 214 does not rely solely on gross weight 1 or gross weight 2 to determine the gross weight of the aircraft 100 at the arrival location 105. Instead, the gross weight determination control unit 214 generates an accurate gross weight determination and prediction based on both gross weight 1 and gross weight 2 of the aircraft 100.

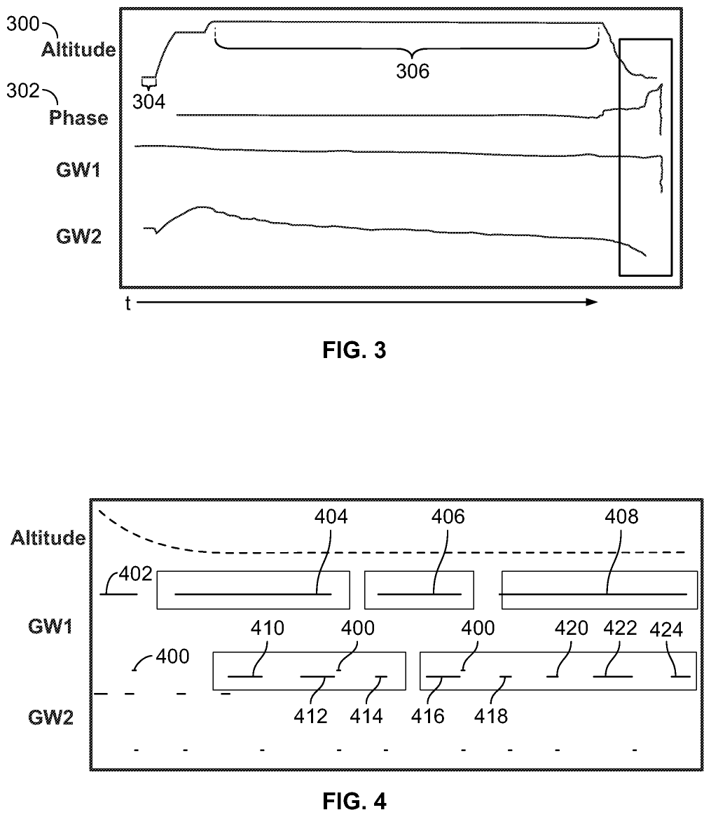

FIG. 3 illustrates graphs of altitude 300, phase 302, gross weight 1 (GW1), and gross weight 2 (GW2) of the aircraft 100 (shown in FIGS. 1 and 2) over time t. As shown, the altitude 300 of the aircraft 100 differs at different phases. For example, the altitude 300 at a taxi and takeoff phase 304 is at ground level, while the altitude 300 may be relatively constant during a cruising phase 306.

As shown, gross weight 1 may assume a constant fuel burn from departure until landing. Conversely, gross weight 2 provides varying fuel burn determinations between departure and landing, due to actual detection of weight parameters (such as fuel burn) during in-air phases of a flight.

FIG. 4 illustrates graphs of gross weight 1 and gross weight 2 of the aircraft 100 (shown in FIGS. 1 and 2) over time. As shown, both gross weight 1 and gross weight 2 may include data gaps 400 during a flight of the aircraft 100. For example, during a flight, the fuel burn may not be constant (that is, a constant slope indicating a constant and steady fuel burn). Further, during a flight, sensor data may not accurately output fuel burn. For example, during particular maneuvers (such as ascents, descents, banks, and the like) the fuel sensor(s) 208 may not accurately detect the fuel within the fuel tank(s) 210 (shown in FIG. 1), such as when fuel is shifted to a side of a fuel tank during a bank.

Referring to FIGS. 1, 2, and 4, in at least one embodiment, the gross weight determination control unit 214 determines the total gross weight of the aircraft 100 at a current time and a future time (such as when the aircraft lands at the arrival location 105) based on accurate data from gross weight 1 and gross weight 2. For example, the gross weight determination control unit 214 detects accurate gross weight data 402, 404, 406, and 408 from gross weight 1 during various phases of the flight. The gross weight determination control unit 214 ignores the data gaps 400 within the gross weight 1. Similarly, the gross weight determination control unit 214 detects accurate gross weight data 410-424 from gross weight 2 during various phases of the flight. The gross weight determination control unit 214 ignores the data gaps 400 within the gross weight 2. The gross weight determination control unit 214 combines the accurate data 402, 404, 406, and 408 from gross weight 1 and the accurate data 410-424 from gross weight 2 to determine an accurate gross weight of the aircraft 100 at any point during the flight.

The gross weight determination control unit 214 may also use the accurate gross weight of the aircraft 100 to predict a landing weight of the aircraft 100 (such as at point 110 at the arrival location). For example, the gross weight determination control unit 214 may determine the accurate gross weight of the aircraft 100, based on accurate data from gross weight 1 and accurate data from gross weight 2, determine a remaining length of the flight on the flight plan stored in the flight computer 204, and subtract a predicted weight of fuel that is to be burned (that is, a predicted fuel burn) for the remaining duration of the flight to predict the landing weight of the aircraft 100.

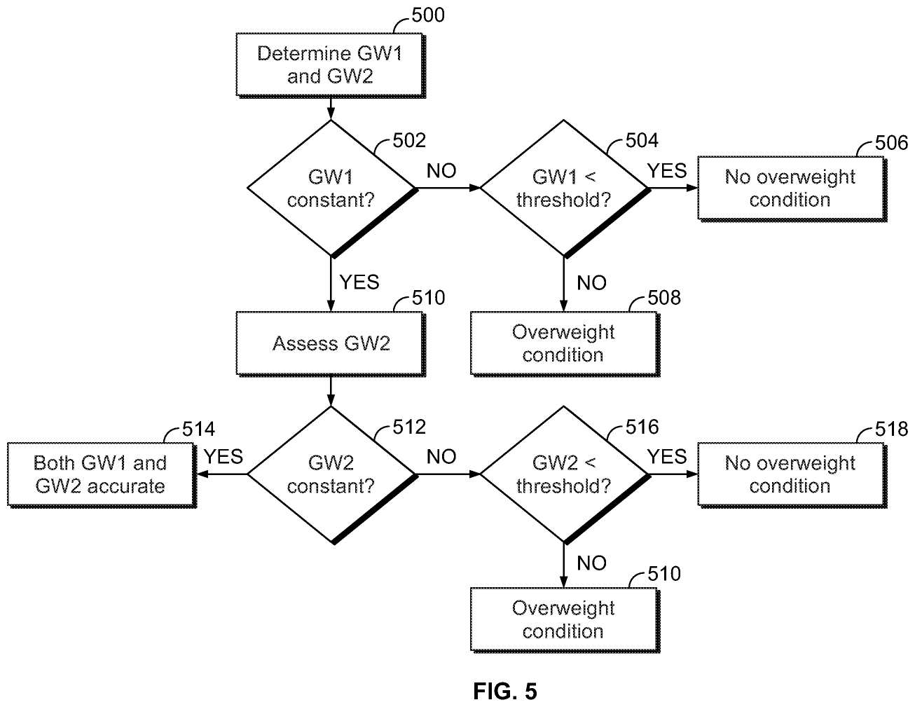

FIG. 5 illustrates a flow chart of an aircraft landing weight determination method, according to an embodiment of the present disclosure. Referring to FIGS. 1-5, the gross weight determination control unit 214 determines gross weight 1 and gross weight 2 at 500 at any point during a flight from the departure gate 102 to the arrival gate 104. As described above, the gross weight 1 is determined based on aircraft weight data input from the pilot and/or automatically through one or more sensors of the aircraft. The gross weight determination control unit 214 then determines gross weight 1 for the aircraft 100 by subtracting a lost fuel weight as determined from a predicted fuel burn for the flight, as determined from the flight plan stored in the flight computer 204, from the aircraft weight data as determined at the departure gate 102. The gross weight 2 is determined from actual data output by various sensors of the aircraft 100 during an in-air portion of the flight of the aircraft, such as between points 106 and 110. The gross weight determination control unit 214 may determine the gross weight 1 and gross weight 2 at any point during the flight, and analyze a remaining flight time and flight path of the aircraft to the arrival location 105 to predict a the gross weight 1 and gross weight 2 at the arrival location 105.

At 502, the gross weight determination control unit 214 determines if the gross weight 1 is constant up until the particular point in the flight (such as at a particular time of a phase of the flight). In at least one embodiment, the gross weight determination control unit 214 determines that the gross weight 1 is constant if there are no data gaps in the gross weight 1 and/or the slope of the gross weight 1 (that is, the decreasing slope, as the weight of the aircraft necessarily decreases as fuel is burn) is constant. If the gross weight 1 is not constant at 502, the gross weight determination control unit 214 determines if the gross weight 1 of the aircraft 100 (whether at the current point in the flight, or at the arrival location 105) is less than a maximum weight threshold for the aircraft 100 as stored in the weight threshold database 216. If the gross weight 1 is less than the maximum weight threshold, the gross weight determination control unit 214 determines that no overweight condition is present at 506. If, however, the gross weight 1 is equal to or greater than the maximum weight threshold, the gross weight determination control unit 214 determines an overweight condition at 508, and may output an overweight condition alert to the pilot of the aircraft 100, such as through one or more graphical, video, and/or audio messages.

If, at 502, the gross weight 1 is constant, the method proceeds to 510, at which the gross weight 2 is assessed. At 512, the gross weight determination control unit 214 determines if the gross weight 2 is constant. If the gross weight 2 is constant (as well as the gross weight 1 being constant), then at 514 the gross weight determination control unit 214 determines that both gross weight 1 and gross weight 2 are both accurate. As such, either the gross weight 1 or the gross weight 2 may be used to provide an accurate determination and/or prediction of gross weight of the aircraft 100.

If, however, the gross weight 2 is not constant at 512, the method proceeds to 516, at which the gross weight determination control unit 214 determines whether the gross weight 2 is less than the maximum weight threshold, as stored in the weight threshold database 216. If the gross weight 2 is less than the maximum weight threshold, the method proceeds to 518, at which the gross weight determination control unit 214 determines that no overweight condition is present. If, however, the gross weight 2 is equal to or greater than the maximum weight threshold at 516, the gross weight determination control unit 214 determines an overweight condition at 520, and may then output an overweight condition alert to the pilot of the aircraft 100.

In response to receiving an overweight condition alert from the gross weight determination control unit 214, a pilot may take remedial action(s) to ensure that the aircraft is under the maximum weight threshold at the arrival location 105. For example, the pilot may request from air traffic control to be placed in a holding pattern to burn additional fuel before landing so that the aircraft 100 is under the maximum weight threshold upon landing. As another example, the pilot may request from air traffic control an alternate (for example, longer) route to the arrival location so that additional fuel is burned before landing.

In at least one embodiment, an aircraft landing weight determination method is configured to determine an accurate gross weight of an aircraft. The aircraft landing weight determination method includes determining, by the gross weight determination control unit 214 an accurate gross weight of an aircraft based on a first source of gross weight data of the aircraft and a second source of gross weight data of the aircraft. In at least one embodiment, the first source of gross weight data is gross weight 1, and the second source of gross weight data is gross weight 2.

In at least one embodiment, the determining includes comparing the gross weight 1 to a maximum weight threshold in response to determining that the gross weight 1 is not constant during at least a portion of a flight, comparing the gross weight 2 to the maximum weight threshold in response to determining that the gross weight 1 is constant and the gross weight 2 is not constant during at least a portion of a flight, and determining that the aircraft is in an overweight condition when the gross weight 1 or the gross weight 2 exceeds the maximum weight threshold. The determining may include determining the accurate gross weight of the aircraft at any point during a flight of the aircraft between a departure gate at a departure location and an arrival gate at an arrival location. In at least one embodiment, the aircraft landing weight determination method also includes predicting, by the gross weight determination control unit 214, a gross weight of the aircraft at an arrival location before landing based on the accurate gross weight of the aircraft.

In at least one embodiment, the determining includes ignoring first data gaps in the first source, ignoring second data gaps in the second source, combining accurate gross weight data from the first source and the second source, and determining the accurate gross weight of the aircraft based on the combining.

As used herein, the term “control unit,” “central processing unit,” “unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the gross weight determination control unit 214 may be or include one or more processors that are configured to control operation thereof, as described herein.

The gross weight determination control unit 214 is configured to execute a set of instructions that are stored in one or more data storage units or elements (such as one or more memories), in order to process data. For example, the gross weight determination control unit 214 may include or be coupled to one or more memories. The data storage units may also store data or other information as desired or needed. The data storage units may be in the form of an information source or a physical memory element within a processing machine.

The set of instructions may include various commands that instruct the gross weight determination control unit 214 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units, such as the gross weight determination control unit 214. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the gross weight determination control unit 214 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

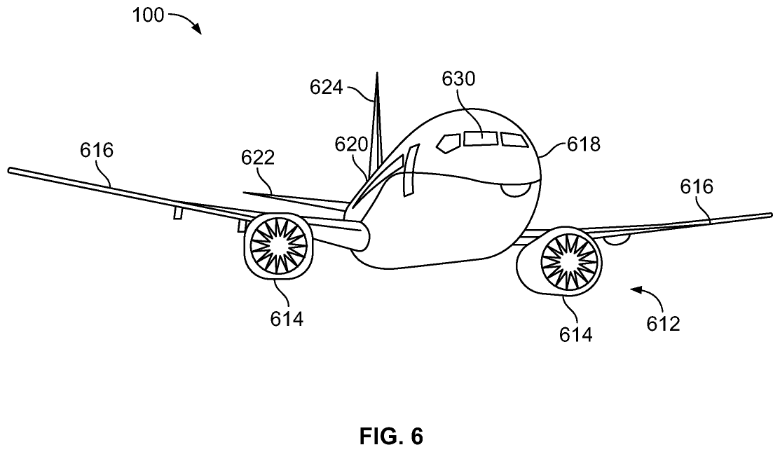

FIG. 6 is a diagrammatic representation of a front perspective view of the aircraft 100, according to an exemplary embodiment of the present disclosure. The aircraft 100 includes a propulsion system 612 that may include two turbofan engines 614, for example. Optionally, the propulsion system 612 may include more engines 614 than shown. The engines 614 are carried by wings 616 of the aircraft 100. In other embodiments, the engines 614 may be carried by a fuselage 618 and/or an empennage 620. The empennage 620 may also support horizontal stabilizers 622 and a vertical stabilizer 624. The fuselage 618 of the aircraft 100 defines an internal cabin, which may include a cockpit 630.

The aircraft 100 may be sized, shaped, and configured other than shown in FIG. 6. For example, the aircraft 100 may be a non-fixed wing aircraft, such as a helicopter. As another example, the aircraft 100 may be an unmanned aerial vehicle (UAV).

As described herein, embodiments of the present disclosure provide systems and methods for accurately estimating and determining a gross weight of an aircraft. Further, embodiments of the present disclosure provide systems and methods that allow an aircraft operator to confidently predict a gross weight of an aircraft at an arrival location. Moreover, embodiments of the present disclosure provide systems and methods for accurately determining a gross weight of an aircraft during a flight and predict the gross weight upon landing.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

1. An aircraft landing weight determination system that is configured to determine an accurate gross weight of an aircraft, the aircraft landing weight determination system comprising:
a gross weight determination control unit that is configured to determine an accurate gross weight of an aircraft based on a first source of gross weight data of the aircraft and a second source of gross weight data of the aircraft.

2. The aircraft landing weight determination system of claim 1, wherein the first source of gross weight data is gross weight 1, wherein the gross weight 1 is initially determined when the aircraft is at a departure gate at a departure location.

3. The aircraft landing weight determination system of claim 2, wherein the gross weight 1 is an initial gross weight at the departure gate minus fuel burn between the departure gate and an arrival gate at an arrival location.

4. The aircraft landing weight determination system of claim 2, wherein the gross weight determination control unit compares the gross weight 1 to a maximum weight threshold in response to determining that the gross weight 1 is not constant during at least a portion of a flight to determine if the aircraft is in an overweight condition.

5. The aircraft landing weight determination system of claim 2, wherein the second source of gross weight data is gross weight 2, wherein the gross weight 2 is determined when the aircraft is off ground and in the air.

6. The aircraft landing weight determination system of claim 5, wherein the gross weight 2 is determined from actual flight data when the aircraft is off the ground.

7. The aircraft landing weight determination system of claim 5, wherein the gross weight determination control unit compares the gross weight 2 to a maximum weight threshold in response to determining that the gross weight 1 is constant and the gross weight 2 is not constant during at least a portion of a flight to determine if the aircraft is in an overweight condition.

8. The aircraft landing weight determination system of claim 1, wherein the gross weight determination control unit determines the accurate gross weight of the aircraft at any point during a flight of the aircraft between a departure gate at a departure location and an arrival gate at an arrival location.

9. The aircraft landing weight determination system of claim 1, wherein the gross weight determination control unit predicts a gross weight of the aircraft at an arrival location before landing based on the accurate gross weight of the aircraft.

10. The aircraft landing weight determination system of claim 1, further comprising a flight computer in communication with the gross weight determination control unit, wherein the flight computer stores flight data for the aircraft.

11. The aircraft landing weight determination system of claim 1, further comprising one or more fuel sensors in communication with the gross weight determination control unit, wherein the one or more fuel sensors are configured to determine an amount of fuel onboard the aircraft.

12. The aircraft landing weight determination system of claim 1, further comprising one or more weight sensors in communication with the gross weight determination control unit, wherein the one or more weight sensors are configured to detect a gross weight of the aircraft.

13. The aircraft landing weight determination system of claim 1, further comprising a weight threshold database in communication with the gross weight determination control unit, wherein the weight threshold database stores a maximum weight threshold for the aircraft at an arrival location, and wherein the gross weight determination control unit is configured to compare the accurate gross weight of the aircraft with the maximum weight threshold to determine if the aircraft is in an overweight condition.

14. The aircraft landing weight determination system of claim 1, wherein the gross weight determination control unit ignores first data gaps in the first source, wherein the gross weight determination control unit ignores second data gaps in the second source, and wherein the gross weight determination control unit combines accurate gross weight data from the first source and the second source to determine the accurate gross weight of the aircraft.

15. An aircraft landing weight determination method that is configured to determine an accurate gross weight of an aircraft, the aircraft landing weight determination method comprising:
determining, by a gross weight determination control unit, an accurate gross weight of an aircraft based on a first source of gross weight data of the aircraft and a second source of gross weight data of the aircraft.

16. The aircraft landing weight determination method of claim 15, wherein the first source of gross weight data is gross weight 1, wherein the gross weight 1 is initially determined when the aircraft is at a departure gate at a departure location, wherein the gross weight 1 is an initial gross weight at the departure gate minus fuel burn between the departure gate and an arrival gate at an arrival location, wherein the second source of gross weight data is gross weight 2, wherein the gross weight 2 is determined when the aircraft is off ground and in the air, and wherein the gross weight 2 is determined from actual flight data when the aircraft is off ground.

17. The aircraft landing weight determination method of claim 16, wherein the determining comprises:
comparing the gross weight 1 to a maximum weight threshold in response to determining that the gross weight 1 is not constant during at least a portion of a flight;
comparing the gross weight 2 to the maximum weight threshold in response to determining that the gross weight 1 is constant and the gross weight 2 is not constant during at least a portion of a flight; and
determining that the aircraft is in an overweight condition when the gross weight 1 or the gross weight 2 exceeds the maximum weight threshold.

18. The aircraft landing weight determination method of claim 15, wherein the determining comprises determining the accurate gross weight of the aircraft at any point during a flight of the aircraft between a departure gate at a departure location and an arrival gate at an arrival location.

19. The aircraft landing weight determination method of claim 15, further comprising predicting, by the gross weight determination control unit, a gross weight of the aircraft at an arrival location before landing based on the accurate gross weight of the aircraft.

20. The aircraft landing weight determination method of claim 15, wherein the determining comprises:
ignoring first data gaps in the first source;
ignoring second data gaps in the second source;
combining accurate gross weight data from the first source and the second source; and
determining the accurate gross weight of the aircraft based on the combining.
